(19) United States
(12) Patent Application Publication
(10) Pub. No.: US 2021/0137113 A1
(43) Pub. Date: May 13, 2021

(54) LIQUID SUSPENSION CONCENTRATE FORMULATION COMPRISING MEFENTRIFLUCONAZOLE

(71) Applicant: SUMITOMO CHEMICAL COMPANY, LIMITED, Tokyo (JP)

(72) Inventor: Hiroto TADA, Takarazuka-shi (JP)

(73) Assignee: SUMITOMO CHEMICAL COMPANY, LIMITED, Tokyo (JP)

(21) Appl. No.: 17/150,530

(22) Filed: Jan. 15, 2021

Related U.S. Application Data
(63) Continuation-in-part of application No. 16/990,791, filed on Aug. 11, 2020.
Application No. 16/990,791 is a continuation of application No. 16/937,352, filed on Jul. 23, 2020.
Application No. 16/937,352 is a continuation of application No. 16/508,004, filed on Jul. 10, 2019, now abandoned.

(30) Foreign Application Priority Data
May 31, 2019 (JP) 2019-102247

(51) Int. Cl. A01N 43/653; A01N 25/04; A01N 25/30

(52) U.S. Cl. CPC A01N 43/653; A01N 25/30; A01N 25/04

(57) ABSTRACT

An object of the present invention is to provide an aqueous suspension concentrate, which shows excellent plant disease control. An aqueous suspension comprising mefentrifluconazole and an antifreeze agent selected from propylene glycol and glycerol.

### CROSS-REFERENCE TO RELATED APPLICATIONS

This application is a Continuation-in-Part of copending U.S. application Ser. No. 16/990,791, filed on Aug. 11, 2020, which is a Continuation of U.S. application Ser. No. 16/937,352, filed on Jul. 23, 2020, which is a Continuation of U.S. application Ser. No. 16/508,004, filed on Jul. 10, 2019 (now abandoned), and under 35 U.S.C. § 119(a) to Application No. 2019-102247, filed in Japan on May 31, 2019, all of which are hereby expressly incorporated by reference into the present application.

### BACKGROUND OF THE INVENTION

### Field of the Invention

The present invention relates to a liquid suspension concentrate formulation comprising mefentrifluconazole.

### Description of the Related Art

Conventionally, as one of forms of pesticide formulations, aqueous suspension concentrates referred to as SCs, in which particles of a solid pesticidally active ingredient are suspended in water, are known. SCs may include an antifreeze agent such as glycerol or propylene glycol.

Mefentrifluconazole is known as a fungicidal active ingredient of a plant disease control agent (see, for example, US Patent Application Publication No. 2014/0155262 A and WO 2017/102905).

### CITATION LIST

### Patent Documents

Patent Document 1: US-2014-0155262-A1

Patent Document 2: WO 2017/102905-A1

### SUMMARY OF THE INVENTION

An object of the present invention is to provide an aqueous suspension concentrate comprising mefentrifluconazole and an antifreeze agent, which shows excellent plant disease controlling effect.

The present inventor has intensively studied so as to find an aqueous suspension concentrate comprising mefentrifluconazole, which shows excellent plant disease controlling effect, and found that mefentrifluconazole and an antifreeze agent synergistically control plant diseases.

More specifically, the present invention is as described below.

[1] An aqueous suspension concentrate comprising mefentrifluconazole and an antifreeze agent selected from propylene glycol and glycerol.

[2] The aqueous suspension concentrate according to [1], wherein a weight ratio of mefentrifluconazole to the antifreeze agent is from 1:0.1 to 1:1.

[3] A method for controlling plant diseases comprising a step of applying the aqueous suspension concentrate according to [1] to plants or their habitat.

According to the present invention, it is possible to provide an aqueous suspension concentrate comprising mefentrifluconazole and an antifreeze agent, which shows excellent plant disease controlling effect.

### DETAILED DESCRIPTION OF THE PREFERRED EMBODIMENTS

An aqueous suspension according to the present invention (hereinafter referred to as the suspension of the present invention) comprises mefentrifluconazole.

Mefentrifluconazole is a known compound and described, for example, in US Patent Application Publication No. 2014/0155262 A and WO 2017/102905. Mefentrifluconazole can be synthesized by the method as described in US Patent Application Publication No. 2014/0155262 A and WO 2017/102905.

The suspension of the present invention comprises mefentrifluconazole in an amount of usually 1 to 60% by weight, preferably 3 to 50% by weight.

The suspension of the present invention comprises an antifreeze agent.

Antifreeze agents used in the present invention include propylene glycol (hereinafter referred to as PG) or glycerol (hereinafter referred to as GL). The content of the antifreeze agent in total amount of the suspension of the present invention is usually 1 to 10% by weight, preferably 2 to 8% by weight.

The suspension of the present invention may comprise one or more surfactants selected from anionic surfactants and nonionic surfactants (hereinafter sometimes referred to as the present surfactant(s)). Preferred anionic surfactants are sulfonates, sulfates, phosphates, carboxylates, and mixtures thereof. Examples of sulfonates include naphthalene sulfonate and formaldehyde condensate thereof, alkyl benzene sulfonate, alkyl naphthalene sulfonate, alkyl diphenyl ether disulfonate, α-olefin sulfonate, lignin sulfonate, polyoxyethylene alkyl phenyl ether sulfonate, and dialkyl sulfosuccinate. Examples of sulfates include alkyl sulfate, polyoxyethylene alkyl ether sulfate, and polyoxyethylene alkyl phenyl ether sulfate. Examples of phosphates include polyoxyethylene alkyl aryl ether phosphate and polyoxyethylene tristyryl phenyl ether phosphate. Examples of carboxylates include fatty acid salt and polycarboxylic acid salt. Examples of nonionic surfactants include polyoxyethylene alkyl ether, polyoxypropylene alkyl ether, polyoxyethylene polyoxypropylene alkyl ether, polyoxyethylene distyryl phenyl ether, polyoxyethylene tristyryl phenyl ether, sucrose fatty acid ester, sorbitan fatty acid ester, polyoxyethylene sorbitan fatty acid ester, glycerol fatty acid ester, polyoxyethylene fatty acid ester, polyoxyethylene alkylamine, alkyl alkanolamide, polyoxyethylene polyoxypropylene block copolymer, alkyl polyglycoside, and acrylic co-polymer.

The suspension of the present invention may comprise the present surfactant(s) in an amount of usually 0.5 to 30% by weight, preferably 1 to 20% by weight or 1 to 15% by weight.

The suspension of the present invention comprises water. Examples of water include ion-exchanged water, tap water, and underground water.

The suspension of the present invention comprises water in an amount of usually 30 to 98% by weight, preferably 40 to 90% by weight.

The suspension of the present invention may optionally comprise any other auxiliary agents for formulation. Examples of other auxiliary agents for formulation include thickeners, preservatives, and antifoam agents. Suitable thickeners are polysaccharides such as xanthan gum, clays, and silicates. When the suspension of the present invention comprises a thickener, the content of the thickener in total amount of the suspension of the present invention is usually 0.05 to 5% by weight, preferably 0.07 to 3% by weight. Suitable preservatives are isothiazolinone preservatives. When the suspension of the present invention comprises a preservative, the content of the preservative in total amount of the suspension of the present invention is usually 0.05 to 0.5% by weight, preferably 0.1 to 0.3% by weight. Suitable antifoam agents are silicone-based antifoam agents. When the suspension of the present invention comprises an antifoam agent, the content of the antifoam agent in total amount of the suspension of the present invention is usually 0.01 to 1% by weight, preferably 0.05 to 0.5% by weight. The suspension of the present invention comprises mefentrifluconazole, the present surfactant(s), and water in a total amount of 50% by weight or more, 60% by weight or more, or 70% by weight or more. In addition, the suspension of the present invention comprises mefentrifluconazole, the present surfactant(s), water, and a thickener in a total amount of 55% by weight or more, 65% by weight or more, or 75% by weight or more.

The suspension of the present invention may further comprise one or more other pesticidally active ingredients. The other pesticidally active ingredient is preferably a solid pesticidally active ingredient.

The suspension of the present invention can be prepared by methods known per se for the preparation of SCs, for example by mixing mefentrifluconazole, the present surfactant(s), and water, and, optionally further other auxiliary agents for formulation.

The method for producing the suspension of the present invention will be exemplified below.

A1) One or more pesticidally active ingredients, the present surfactant(s), and water, and, if necessary, auxiliary agents for formulation are mixed to obtain a suspension. As the pesticidally active ingredients, mefentrifluconazole and, if necessary, other pesticidally active ingredients can be used.
A2) The obtained suspension is fed to a grinder such as a bead mill to grind the pesticidally active ingredient in the suspension, thereby obtaining a suspension (hereinafter referred to as a ground suspension).
A3) One or more thickeners, one or more antifreeze agents and the like are added to the obtained ground suspension as necessary, and mixed to obtain a suspension of the present invention.

In the case of adding a part, not the entire amount, of the present surfactant in the step A1), the remaining present surfactant is added to the ground suspension in the step A3) after grinding. The operation of adding the present surfactant in each of the steps A1) and A3) is referred to as divided addition of the surfactant herein.

Plant diseases can be controlled by applying the suspension of the present invention to plants or their habitat. Examples of plant diseases include the followings.

Rice diseases: blast (Magnaporthe grisea), brown spot (Cochliobolus miyabeanus), sheath blight (Rhizoctonia solani), bakanae disease (Gibberella fujikuroi), and downy mildew (Sclerophthora macrospora);

Wheat diseases: powdery mildew (Erysiphe graminis), fusarium blight (Fusarium gaminearum, F. avenaceum, F. culmorum, Microdochium nivale), rust (Puccinia striiformis, P. graminis, P. recondita), snow mould (Micronectriella nivale, M. majus), typhulasnow blight (Typhula sp.), loose smut (Ustilago tritici), stinking smut (Tilletia caries, T. controversa), eyespot (Pseudocercosporella herpotrichoides), leaf blotch (Septoria tritici), glume blotch (Stagonospora nodorum), tan spot (Pyrenophora tritici-repentis), rhizoctonia seeding blight (Rhizoctonia solani), and take-all disease (Gaeumannomyces graminis);

Barly diseases: powdery mildew (Erysiphe graminis), fusarium blight (Fusarium gaminearum, F. avenaceum, F. culmorum, Microdochium nivale), rust (Puccinia striiformis, P. graminis, P. hordei), loose smut (Ustilago nuda), scald (Rhynchosporium secalis), net blotch (Pyrenophora teres), spot blotch (Cochliobolus sativus), leaf stripe (Pyrenophora graminea), Ramularia disease (Ramularia collocygni), and rhizoctonia seeding blight (Rhizoctonia solani);

Corn diseases: rust (Puccinia sorghi), southern rust (Puccinia polysora), northern leaf blight (Setosphaeria turcica), tropical rust (Physopella zeae), southern leaf blight (Cochliobolus heterostrophus), anthracnose (Colletotrichum gfaminicola), gray leaf spot (Cercospora zeae-maydis), eyespot (Kabatiella zeae), phaeosphaeria leaf spot (Phaeosphaeria maydis), diplomat over Deer disease (Stenocarpella maydis, Stenocarpella macrospora), Stalk Rot (Fusarium graminearum, Fusarium verticilioides, Colletotrichum graminicola), corn smut (Ustilago maydis);

Cotton diseases: anthracnose (Colletotrichum gossypii), grey mildew (Ramuraria areola), alternaria leaf spot (Alternaria macrospora, A. gossypii), Black root rot due to Thielaviopsis spp. (Thielaviopsis basicola);

Coffee diseases: rust (Hemileia vastatrix), leaf spot (Cercospora coffeicola);

Rape seed diseases: sclerotinia rot (Sclerotinia sclerotiorum), black spot (Alternaria brassicae), and black leg (Phoma lingam);

Sugarcane diseases: rust (Puccinia melanocephela, Puccinia kuehnii), and smut (Ustilago scitaminea);

Sunflower diseases: rust (Puccinia helianthi), and downy mildew (Plasmopara halstedii);

Citrus diseases: melanose (Diaporthe citri), scab (Elsinoe fawcetti), fruit rot (Penicillium digitatum, P. italicum), and epidemics (Phytophthora parasitica, Phytophthora citrophthora);

Apple diseases: blossom blight (Monilinia mali), canker (Valsa ceratosperma), powdery mildew (Podosphaera leucotricha), alternaria leaf spot (Alternaria alternata apple pathotype), scab (Venturia inaequalis), anthracnose (Glomerella cingulata), brown spot (Diplocarpon mali), ring spot (Botryosphaeria berengeriana), and epidemics (Phytophtora cactorum);

Pear diseases: scab (Venturia nashicola, V. pirina), black spot (Alternaria alternata Japanese pear pathotype) and rust (Gymnosporangium haraeanum);

Peach diseases: brown rot (Monilinia fructicola), scab (Cladosporium carpophilum) and Phomopsis rot (Phomopsis sp.);

Grapes diseases: anthracnose (Elsinoe ampelina), ripe rot (Glomerella cingulata), powdery mildew (Uncinula necator), rust (Phakopsora ampelopsidis), black rot (Guignardia bidwellii), and downy mildew (Plasmopara viticola);

Diseases of Japanese persimmon: anthracnose (Gloeosporium kaki) and leaf spot (Cercospora kaki, Mycosphaerella nawae);

Diseases of gourd family: anthracnose (Colletotrichum lagenarium), powdery mildew (Sphaerotheca fuliginea), gummy stem blight (Didymella bryoniae), target spot (Corynespora cassiicola), fusarium wilt (Fusarium oxysporum), downy mildew (Pseudoperonospora cubensis), epidemics (Phytophthora sp.) and damping-off (Pythium sp.);

Tomato diseases: early blight (Alternaria solani), leaf mold (Cladosporium fulvum), leaf mold (Pseudocercospora fuligena), late blight (Phytophthora infestans), and powdery mildew (Leveillula taurica);

Eggplant disease: brown spot (Phomopsis vexans) and powdery mildew (Erysiphe cichoracearum);

Diseases of Cruciferous Vegetables: alternaria leaf spot (Alternaria japonica), white spot (Cercosporella brassicae), clubroot (Plasmodiophora parasitica), downy mildew (Peronospora parasitica);

Welsh onion diseases: rust (Puccinia allii);

Soybean diseases: purple stain (Cercospora kikuchii), sphaceloma scad (Elsinoe glycines), pod and stem blight (Diaporthe phaseolorum var. sojae), rust (Phakopsora pachyrhizi), target spot (Corynespora cassiicola), anthracnose (Colletotrithum glycines, C. truncatum), Rhizoctonia aerial blight (Rhizoctonia solani), septoria brown spot (Septoria glycines), frog eye leaf spot (Cercospora sojina), sclerotal disease (Sclerotinia sclerotiorum), Powdery mildew (Microsphaera diffusa), Stem plague (Phytophthora sojae), downy mildew (Peronospora manshurica), sudden death (Fusarium virguliforme);

Kindney bean diseases: Crown rot (Sclerotinia sclerotiorum), rust (Uromyces appendiculatus), angular leaf spot (Phaeoisariopsis griseola), and anthracnose (Colletotrichum lindemthianum);

Peanut diseases: early leaf spot (Cercospora personata), late leaf spot (Cercospora arachidicola) and southern blight (Sclerotium rolfsii);

Garden pea diseases: powdery mildew (Erysiphe pisi);

Potato diseases: early blight (Alternaria solani), late blight (Phytophthora infestans), Pink rot (Phytophthora erythroseptica), powdery scab (Spongospora subterranean f. sp. subterranea), and verticillium wilt (verticillium albo-atrum, V. dahliae, V. nigrescens);

Strawberry diseases: powdery mildew (Sphaerotheca humuli);

Tea diseases: net blister blight (Exobasidium reticulatum), white scab (Elsinoe leucospila), gray blight (Pestalotiopsis sp.) and anthracnose (Colletotrichum theae-sinensis);

Tabacco diseases: brown spot (Alternaria longipes), powdery mildew (Erysiphe cichoracearum), anthracnose (Colletotrichum tabacum), downy mildew (Peronospora tabacina), and epidemics (Phytophthora nicotianae);

Sugar beet diseases: cercospora leaf spot (Cercospora beticola), leaf blight (Thanatephorus cucumeris), root rot (Thanatephorus cucumeris) and aphanomyces root rot (Aphanomyces cochlioides);

Rose diseases: black spot (Diplocarpon rosae) and powdery mildew (Sphaerotheca pannosa);

Diseases of Chrysanthemum: leaf blight (Septoria chrysanthemi-indici) and white rust (Puccinia horiana);

Onion diseases: botrytis leaf blight (Botrytis cinerea, B. byssoidea, B. squamosa), gray-mold neck rot (Botrytis alli), and small sclerotial rot (Botrytis squamosa);

Various crops diseases: gray mold (Botrytis cinerea), and sclerotinia rot (Sclerotinia sclerotiorum);

Diseases of Japanese radish: alternaria leaf spot (Alternaria brassicicola);

Turfgrass diseases: dollar spot (Sclerotinia homeocarpa), brown patch and large patch (Rhizoctonia solani); and

Banana diseases: Sigatoka disease (Mycosphaerella fijiensis, Mycosphaerella musicola);

Seed diseases or diseases in the early stages of the growth of various plants caused by bacteria of Aspergillus spp., Penicillium spp., Fusarium spp., Gibberella spp., Tricoderma spp., Thielaviopsis spp., Rhizopus spp., Mucor spp., Corticium spp., Phoma spp., Rhizoctonia spp., and Diplodia spp.; and

Viral diseases of various plants mediated by Polymixa genus or Olpidium genus.

Burkholderia plantarii of rice (Burkholderia plantarii); Angular Leaf Spot of Cucumber (Pseudomonas syringae pv. Lachrymans); wilt disease of eggplant (Ralstonia solanacearum); Citrus Canker (Xanthomonas citiri); and Sof rot of white cabbage (Erwinia carotovora).

A user applies the suspension of the present invention usually from a knapsack sprayer, a spray tank, a spray plane, or an irrigation system. Usually, the suspension of the present invention is diluted with water to the desired application concentration and the spray liquor is obtained. Usually, 20 to 2000 L, preferably 50 to 400 L, of the spray liquor are applied per hectare.

The application rate of the suspension of the present invention may be varied depending on a type of plant, a type or a frequency of an occurrence of plant diseases to be controlled, an application period, an application method, an application site, a climate condition and the like. The application rate of the suspension of the present invention is usually 10 to 100 g per hectare as an amount of mefentrifluconazole.

### EXAMPLES

Hereinafter, the present invention will be described in more detail by way of examples and test examples.

First, the components used for the preparation of an aqueous suspension are indicated below.

Rhodasurf 860/P (polyoxyethylene alkyl ether, manufactured by Solvay)
Soprophor FLK (40% by weight of polyoxyethylene tristyryl phenyl ether phosphate and 60% by weight of propylene glycol, manufactured by Solvay)
Atlox 4913 (30 to 35% by weight of an acrylic copolymer, and 65 to 70% by weight, in total, of propylene glycol and water, manufactured by Croda)
XIAMETER ACP-1500 (silicone-based antifoam agent, manufactured by Toray Dow Corning)
KELZAN S (xanthan gum, manufactured by CP Kelco),
VEEGUM R (magnesium aluminum silicate, manufactured by R. T. Vanderbilt Co., Inc.)
Propylene glycol (manufactured by Adeka)

### Example 1

Ten (10) parts by weight of mefentrifluconazole, 1.2 parts by weight of Rhodasurf 860/P, 0.2 parts by weight of exchanged water were mixed to obtain a mixture. The mixture and glass beads having a diameter of 1 mm and twice the weight of the mixture were placed in a container. Then, the container was set into a planetary centrifugal mixer (Awatori rentaro, manufactured by THINKY CORPORATION) and the mixture was stirred under conditions: a rotation number of 2000 rpm and room temperature (about 25° C.) for wet grinding, thereby obtaining 85.5 parts by weight of a ground suspension. 0.2 parts by weight of KELZAN S, 0.4 parts by weight of VEEGUM R, 5 parts by weight of propylene glycol, and 7.7 parts by weight of ion-exchanged water were mixed to obtain 13.3 parts by weight of a thickener-containing liquid.

85.5 parts by weight of the ground suspension, 1.2 parts by weight of Rhodasurf 860/P and 13.3 parts by weight of the thickener-containing liquid were mixed to obtain an aqueous suspension of the present invention (hereinafter referred to as Present Suspension 1).

### Example 2

Ten (10) parts by weight of mefentrifluconazole, 1.2 parts by weight of Rhodasurf 860/P, 3 parts by weight of Soprophor FLK, 0.2 parts by weight of XIAMETER ACP-1500, and 72.3 parts by weight of ion-exchanged water were mixed to obtain a mixture. The mixture and glass beads having a diameter of 1 mm and twice the weight of the mixture were placed in a container. Then, the container was set into a planetary centrifugal mixer (Awatori rentaro, manufactured by THINKY CORPORATION) and the mixture was stirred under conditions: a rotation number of 2000 rpm and room temperature (about 25° C.) for wet grinding, thereby obtaining 86.7 parts by weight of a ground suspension. 0.2 parts by weight of KELZAN S, 0.4 parts by weight of VEEGUM R, 5 parts by weight of propylene glycol, and 7.7 parts by weight of ion-exchanged water were mixed to obtain 13.3 parts by weight of a thickener-containing liquid.

86.7 parts by weight of the ground suspension and 13.3 parts by weight of the thickener-containing liquid were mixed to obtain an aqueous suspension of the present invention (hereinafter referred to as Present Suspension 2).

### Example 3

Ten (10) parts by weight of mefentrifluconazole, 4 parts by weight of Atlox 4913, 0.2 parts by weight of XIAMETER ACP-1500, and 72.5 parts by weight of ion-exchanged water were mixed to obtain a mixture. The mixture and glass beads having a diameter of 1 mm and twice the weight of the mixture were placed in a container. Then, the container was set into a planetary centrifugal mixer (Awatori rentaro, manufactured by THINKY CORPORATION) and the mixture was stirred under conditions: a rotation number of 2000 rpm and room temperature (about 25° C.) for wet grinding, thereby obtaining 86.7 parts by weight of a ground suspension. 0.2 parts by weight of KELZAN S, 0.4 parts by weight of VEEGUM R, 5 parts by weight of propylene glycol, and 7.7 parts by weight of ion-exchanged water were mixed to obtain 13.3 parts by weight of a thickener-containing liquid.

86.7 parts by weight of the ground suspension and 13.3 parts by weight of the thickener-containing liquid were mixed to obtain an aqueous suspension of the present invention (hereinafter referred to as Present Suspension 3).

### Example 4

Ten (10) parts by weight of mefentrifluconazole, 3 parts by weight of Soprophor FLK, 0.2 parts by weight of XIAMETER ACP-1500, and 67.5 parts by weight of ion-exchanged water were mixed to obtain a mixture. The mixture and glass beads having a diameter of 1 mm and twice the weight of the mixture were placed in a container. Then, the container was set into a planetary centrifugal mixer (Awatori rentaro, manufactured by THINKY CORPORATION) and the mixture was stirred under conditions: a rotation number of 2000 rpm and room temperature (about 25° C.) for wet grinding, thereby obtaining 80.7 parts by weight of a ground suspension. 0.2 parts by weight of KELZAN S, 0.4 parts by weight of VEEGUM R, 5 parts by weight of propylene glycol, and 7.7 parts by weight of ion-exchanged water were mixed to obtain 13.3 parts by weight of a thickener-containing liquid.

80.7 parts by weight of the ground suspension, 6 parts by weight of Soprophor FLK, and 13.3 parts by weight of the thickener-containing liquid were mixed to obtain an aqueous suspension of the present invention (hereinafter referred to as Present Suspension 4).

### Example 5

Ten (10) parts by weight of mefentrifluconazole, 4 parts by weight of Atlox 4913, 0.2 parts by weight of XIAMETER ACP-1500, and 68.5 parts by weight of ion-exchanged water were mixed to obtain a mixture. The mixture and glass beads having a diameter of 1 mm and twice the weight of the mixture were placed in a container. Then, the container was set into a planetary centrifugal mixer (Awatori rentaro, manufactured by THINKY CORPORATION) and the mixture was stirred under conditions: a rotation number of 2000 rpm and room temperature (about 25° C.) for wet grinding, thereby obtaining 82.7 parts by weight of a ground suspension. 0.2 parts by weight of KELZAN S, 0.4 parts by weight of VEEGUM R, 5 parts by weight of propylene glycol, and 7.7 parts by weight of ion-exchanged water were mixed to obtain 13.3 parts by weight of a thickener-containing liquid.

82.7 parts by weight of the ground suspension, 4 parts by weight of Atlox 4913, and 13.3 parts by weight of the thickener-containing liquid were mixed to obtain an aqueous suspension of the present invention (hereinafter referred to as Present Suspension 5).

### Test Example 1

Each of the Present Suspensions shows synergistically active control of a plant disease compared to PG or the PG-free Present Suspension alone.

What is claimed is:

1. An aqueous suspension concentrate comprising mefentrifluconazole and an antifreeze agent selected from propylene glycol and glycerol.

2. The aqueous suspension concentrate according to claim 1, wherein a weight ratio of mefentrifluconazole to the antifreeze agent is from 1:0.1 to 1:1.

3. A method for controlling plant diseases comprising a step of applying the aqueous suspension concentrate according to claim 1 to plants or their habitat.
